(19) United States
(12) Patent Application Publication
(10) Pub. No.: US 2003/0144912 A1
(43) Pub. Date: Jul. 31, 2003

(54) Multilingual messaging system and method for e-commerce

(76) Inventor: Todd McGee, Delray Beach, FL (US)

Correspondence Address: GREENBERG TRAURIG, P.A., 1221 Brickell Avenue, Miami, FL, 33131, US

(21) Appl. No.: 10/059,283

(22) Filed: Jan. 29, 2002

(51) Int. Cl. G06F 17/60

(52) U.S. Cl. 705/26

(57) ABSTRACT

The present invention is an Internet-based electronic messaging system that, through the use of system templates and through the system's processing of messages, can enable users who understand a different language to communicate and negotiate business transactions with each other. Users receive and send messages in the language they understand (Korean, for example) and the recipient receives and then sends messages in the language they understand (German, for example). The system creates an electronic commerce platform through a series of template screens for each step of the typical commercial transaction in goods or services, (e.g., request for quotation (“RFQ”) by buyer, quotation by seller, negotiation request by buyer, quotation by seller, purchase order by buyer, purchase order confirmation by seller). A user can perform each step of the ordering process online and, after each step is completed, the user's trading partner is advised via e-mail, instant messaging or other means, that the step has been completed, and the message includes a link back to the system. For example, a buyer could create an RFQ online using the system template in the buyer's own language and, when completed, the seller would be notified via e-mail of the RFQ in the form of the system template in the seller's own language. The seller can then click on a link that accesses the RFQ on the system, also in the seller's own language, which enables the seller to prepare a quotation using the system template in the seller's own language.

### BACKGROUND OF THE INVENTION

1. Field of the Invention

The present invention relates to a method and system for buyers and sellers of goods or services to engage in commerce. More specifically, the present invention relates to a method and system for requesting, quoting, selling and purchasing goods or services through a user interface, such as a web browser, providing users with the ability to transact electronic commerce with other parties who understand different languages.

2. Description of Background Art

Buyers in need of goods and services often spend considerable time locating an appropriate vendor. Buyers typically use trade publications, directories, recommendations, and other means to locate vendors. If the type of vendor needed is in a foreign country, the problem compounds. Vendors advertise through various media and by direct sales methods to make known to potential buyers what they sell and how to contact them. Once a buyer identifies a few vendors, each must be contacted to obtain product or service price and availability information. These processes are costly, require experienced personnel and are time consuming for most businesses.

The market for goods and services in various industries is becoming increasingly global, with orders for such goods or services originating from several countries. It is, therefore, desirable to provide a quick and efficient way to order and/or sell products or services through a global network of computers, such as those connected to each other via the Internet. The Internet is a collection of interconnected (public and/or private) networks that are linked together by a set of standard protocols, such as TCP/IP to form a global, distributed network. While this term is intended to refer to what is now commonly known as the Internet, it is also intended to encompass variations which may be made in the future, including changes and additions to existing standard protocols.

Online transactions are fairly cheaper than traditional channels and means of doing business. For example, a bank may charge on average one dollar for each transaction (such as every day transactions, from verifying the balance of a checking or savings account, to withdrawal of money from a local bank), versus an average of seven cents that it costs to do the same transaction on an online bank. For this reason, Internet and online trading is expected to grow significantly.

With the growth of electronic commerce via the Internet, there has been a need for Internet users of different languages throughout the world to be able to understand and communicate with each other. Several systems have been developed to address this need. Most prior art systems are language translation software applications. For example, U.S. Pat. No. 5,075,850 to Asahioka et al. is directed to a translation communication system having memory for storing previously translated word pairs, so that when new translations are performed, the system retrieves useful stored previous translations. The system enables a user to communicate in his own language with a user that understands a different language. U.S. Pat. No. 5,175,684 to Chong is directed to a machine translation system including an automatic routing system for automatically translating input text from one language to another designated language and sending the output translated text to a designated addressee. The output format is designated by the user as well. A cover page template is used to designate translation and distribution instructions for an input message. Similarly U.S. Pat. No. 5,268,839 to Kaji is directed to an improved translation method and system in which translated words are compared with words previously used by the intended recipient of the translated message to ensure proper translation. U.S. Pat. No. 5,987,401 to Trudeau is directed to a real-time translation of text-based conversation from one language to another, which is essentially a real-time translation engine, and U.S. Pat. No. 6,064,951 Park et al. is directed to a query transformation system and method for retrieval of multi-lingual web documents, which is essentially a query translator to obtain search results in different languages.

Other efforts in the field of multi-lingual communications systems include U.S. Pat. No. 6,092,035 to Kurachi et al. is directed to a multilingual transmission system including a server device and a client device. The system does not have a translation engine—instead, the target language text is analyzed and different interpretations for vague text are provided for the user to select which interpretation is correct. The system produces pivot language data which is used to generate the target language data.

Still more recent efforts include U.S. Pat. No. 6,119,078 to Kobayakawa et al. is directed to a system and method for automatically translating a web page by interpreting the U.R.L. used to request the web page. The system uses multiple dictionaries for improved translation.

The main drawback of such language translation engines is that the translations are often inaccurate due to limitations in the dictionaries forming part of such systems and inability to fully translate the context or connotation of the translated message. Other systems have attempted to improve translation engines to improve their usefulness. For example, U.S. Pat. No. 5,442,546 to Kaji et al. is directed to a system and method for automatically generating translation templates from a pair of bilingual sentences. The system compiles a database of translated phrases that can be used as templates to avoid having to translate each word from scratch every time. The templates consist of a first language sentence template and a second language sentence template which contain variables which can be replaced for various words or phrases and are mutually equivalent. The system reads the first language sentence and its equivalent second language and extracts the elements already forming part of a template and the variable elements are translated into the second language and the entire sentence becomes a new template for future use. Another example is U.S. Pat. No. 5,568,383 to Johnson et al. which is directed to a natural language translation system and document transmission network with translation loss information detection. Information word loss is transmitted to the originator of the message with provisions for specifying criteria under which future translations can occur.

Still another example is U.S. Pat. No. 5,583,761 to Chou, which is directed to a method for automatically displaying program presentations in different languages. The invention translates the screen displays of graphical user interface applications (e.g., status and help messages, static text such as menu items and commands) into desired languages. The invention performs this function independently from the application being translated, and works while said application is running. A preferred embodiment of the present invention provides a method of intercepting and recognizing templates from the target application and substituting those intercepted with a corresponding template which contains a replacement language. The invention handles translation of the display of an application, but does not handle translation of user inputs.

Other efforts include U.S. Pat. No. 5,715,466 to Flanagan et al. is directed to a system for parallel foreign language communication over a computer network. The system permits users who speak different languages to communicate with each other. The system collects messages and translates them into the languages of the various discussion group users. The system uses a message collection/posting software application to perform direct translations of messages, and also identifies words such as company or product names that will be left untranslated.

U.S. Pat. No. 5,944,790 to Levy is directed to a method and apparatus for providing a website having a home page that automatically adapts to user language and customs by identifying a user's location through their e-mail/domain address. U.S. Pat. No. 5,974,372 to Barnes is directed to a graphical user interface translator in which a user selects screens for translation, enters the translated language and saves same for future use without modifying the underlying program.

These prior art systems are configured as either standalone language translation applications or as search query processors, and are not themselves platforms or systems for engaging in electronic commerce. The present invention provides a system and method for engaging in electronic commerce utilizing series of standard e-commerce transactional template screens that are displayed to each user in such user's desired language, such that users can send and receive messages in their own desired language pertaining to transactions with other users who understand and communicate in a different language.

### SUMMARY OF THE INVENTION

The present invention is an Internet-based electronic messaging system that, through the use of system templates and through the system's processing of messages, can enable users who understand a different language to communicate and negotiate business transactions with each other. Users receive and send messages in the language they understand (Korean, for example) and the recipient receives and then sends messages in the language they understand (German, for example). The system creates an electronic commerce platform through a series of template screens for each step of the typical commercial transaction in goods or services, such as, for example but not by way of limitation, request for quotations (“RFQ”) by buyers, quotations by sellers, negotiation requests by buyers, quotations by sellers, purchase orders by buyers, purchase order confirmations by sellers. The screen templates are stored in the system software databases in each language used by system users. The template screens provide details about the proposed transaction, such as the names of the parties, address, telephone and facsimile numbers, email and addresses, shipping, pricing and other standard terms, as well as a space to insert text messages. These items of information are preferably stored in the system databases so that they are only entered once by users, and are automatically retrieved and information provided to transactional counterparties in one or more template screens during the course of the template transactional process. These items of information generally require no translation and are understood by speakers of all languages. The system eliminates the need for a real-time translation engine dictionary and related systems, and yet nothing is lost in translation from one language to another.

A user can perform each step of the ordering process online and, after each step is completed, the user's trading partner is advised via e-mail, instant messaging or other means, that the step has been completed, and the message includes a link back to the system. For example, a buyer could create an RFQ online using the system template in the buyer's own language and, when completed, the seller would be notified via e-mail of the RFQ in the seller's own language. The seller can then click on a link that accesses the RFQ on the system, also in the seller's own language, which enables the seller to prepare a quotation using the system template in the seller's own language.

The templates for each step of the transaction and the associated e-mail messages are translated into multiple languages. This conversion enables the system to publish each step of ordering process in multiple languages. Each buyer user and seller user that registers as a user of the system selects a preferred language for receiving messages from the system.

The system of the invention is implemented via a computer system that communicates information over a network, such as the Internet. The computer system is programmed to run all necessary software, such as search and database applications or search and data-mining applications, for achieving the purpose of the invention.

The system of the present invention is preferably integrated into a full electronic commerce that processes requests for quotations for goods and/or services through one or more central processing units, said system comprising operating system software for controlling said one or more central processing units and storage means containing one or more databases with appropriate identity and other information about members of the network and the goods and services available, one or more servers providing for Internet-based access and use of the system by sellers to upload their inventory data, request for quotation filtering conditions and means for responding to requests for quotations, means for buyers to search the system's seller and product/service databases and submit requests for quotation, means for potential buyers to transmit requests for quotation to system's said central processing unit, means for said system's central processing unit to transmit requests for quotation to selected system network vendor members, means for said vendor members to transmit quotations to the requesting potential buyers in response to their requests for same.

### DESCRIPTION OF DRAWINGS

FIG. 1 is a block diagram of the system of the present invention in a preferred embodiment.

FIG. 2 is a flow chart showing the information process flow of the method of the present invention in a preferred embodiment.

### DESCRIPTION OF A PREFERRED EMBODIMENT

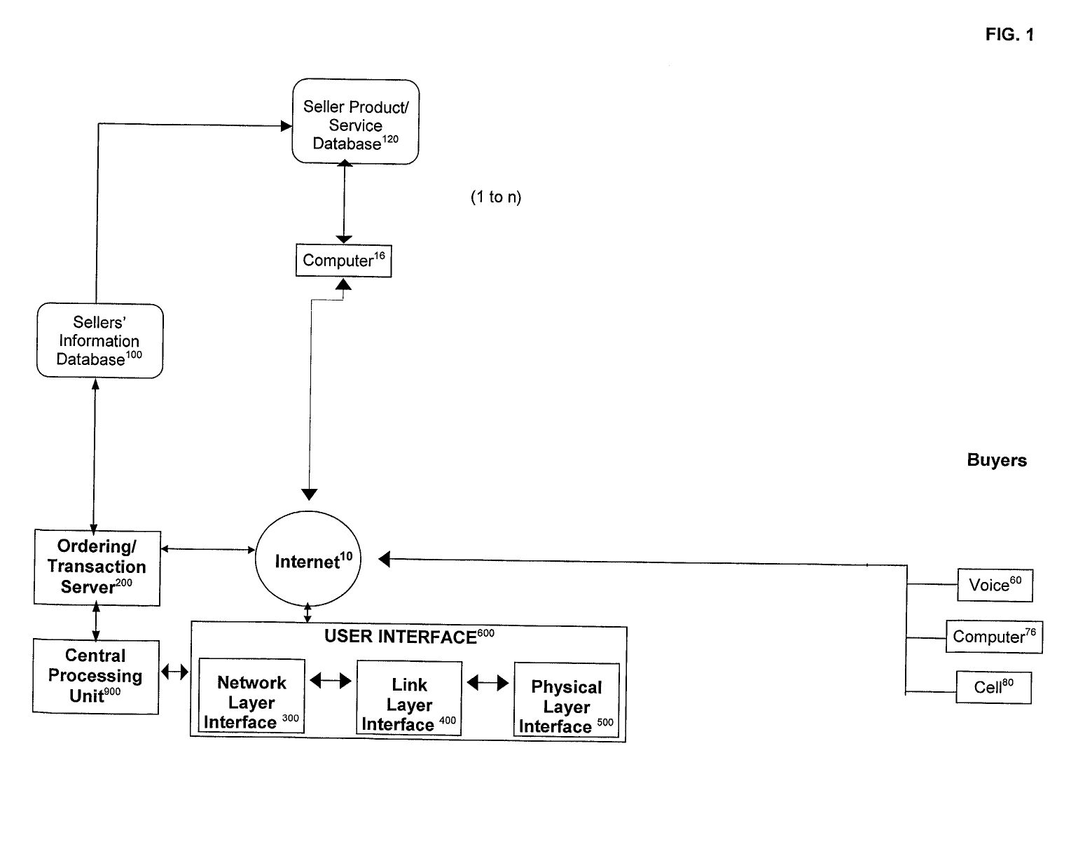

FIG. 1 shows a block diagram of a preferred embodiment of the system that implements the present invention. Communication between buyers, sellers and the system computer(s) is completed using the Internet 10. A world wide web home page is set up to provide access to the system via the Internet to system users. A potential user accesses the Internet using any standard web browser and becomes a system user by completing a registration application providing necessary data about itself. Once registered, a user can access the product/service databases and template forms necessary for preparing an RFQ.

As shown in FIG. 1, a seller information database 100 is connected through a server 200 to a network, such as the Internet 10. In this way, the Internet provides buyers with access to the sellers via the system. Sellers provide their product/service inventory database information to the system via the Internet 10 using computer terminals 16. A buyer interfaces with the system via a user interface 600, such as one that is developed using a well-known markup language protocol, e.g., HTML.

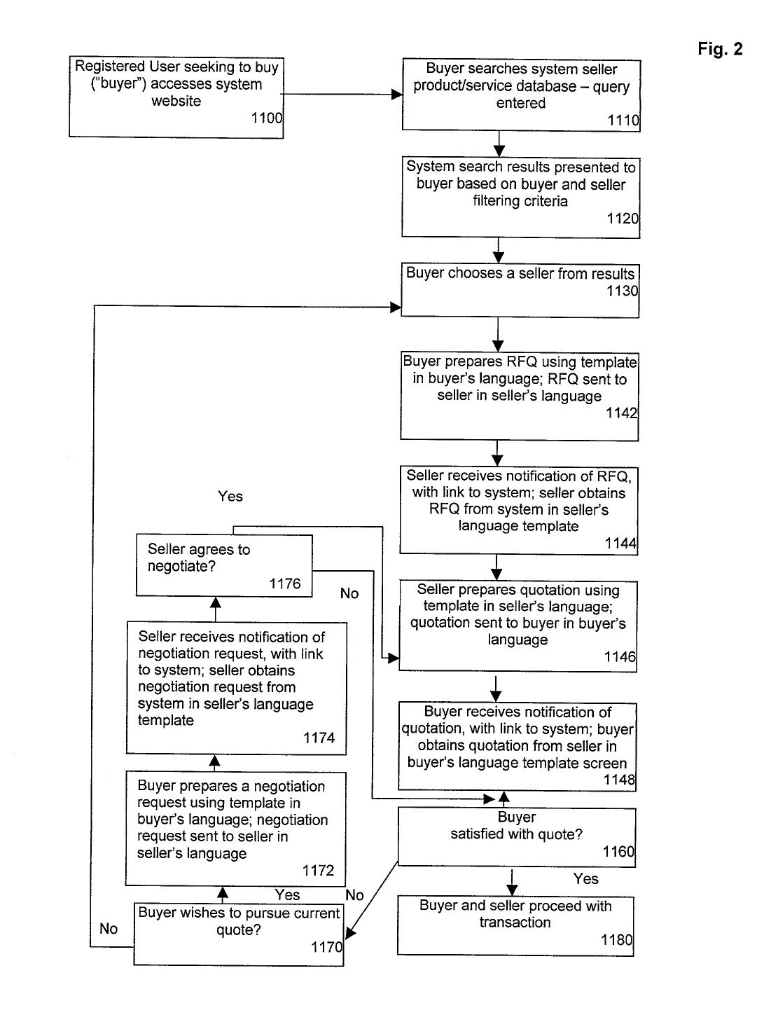

Referring now to FIG. 2, which is a flow diagram showing the overall process flow of the method of the present invention in a preferred embodiment, the method of the present invention begins when registered buyers interact with the system by accessing the system website 1100 and the seller information database provided therein to search for desired items 1110. After completing the search, the buyers are provided with a list of available sellers of the desired products/services based on buyer and seller filtering criteria 1120.

The buyer can then select the seller name to retrieve seller contact information, and contact them to request a quotation, or “RFQ,” using the RFQ template in such user's desired language. Alternatively, users could request a quote using traditional methods such as telephone, fax, e-mail RFQ, or purchase directly from the seller. If unfavorable terms are offered and/or for any other reason, the buyer may alternatively select a brokerage or fulfillment service to facilitate quotation request and/or purchase and accommodate the needs of the buyer. The RFQ is prepared by the buyer using the system's RFQ template in the buyer's language 1142. The RFQ is sent to the seller who receives notification and the RFQ in the system's template forms in the seller's language 1144. The seller then prepares a quotation in response to the request, using the system's quotation template in the seller's language 1146. The quotation is sent to the buyer, who receives the quotation form in the system template in the buyer's language 1148. If the buyer is satisfied with the quote 1160, the transaction proceeds 1180. Otherwise, the buyer can submit a negotiation request to seller or new RFQ's to potential sellers 1170.

New vendors and other users may apply for membership online via the system website. New members would receive password information via e-mail to ensure that they have provided correct e-mail coordinates.

Standardization of product or service descriptions is done to avoid confusion and the need for translation. To this end preprogrammed menu information can be provided to classify products and services in categories broken down by functional class and subclass corresponding to the products as they are commercially known and identified. Such menus can be readily upgraded to include new and revised commercially available products and services from the manufacturers or suppliers of such products and services. All system users understand the product/service descriptions.

Buyers typically include buyers from original equipment manufacturers (“OEM's”), contract electronic manufacturers/contract assembly house's (“CEM's”), independent distributors/brokers, and other entities. Sellers typically include franchised distributors and independent distributors. Since the website is published and marketed in many languages, buyers and sellers can use it worldwide.

In a preferred embodiment involving a sample transaction between a German buyer and a Korean seller of a particular product:

A buyer in Germany (who only speaks German) logged into the German version of the system and performed a search for a good or service and found a seller in Korea (who only speaks Korean) who has stock. The buyer retrieves information regarding the seller in the buyer's own language.

The buyer in Germany then, on the German version of the system, prepares and sends an RFQ using the German RFQ template.

The seller in Korea receives an e-mail advisement (in the seller's preferred language, Korean) of the RFQ. This e-mail would contain a link to the system.

The seller in Korea clicks on the link in their Korean e-mail which opens up a web browser that accesses the actual RFQ page (in the form of the Korean template) on the system.

The seller, based on the RFQ that the seller is viewing in Korean, prepares and sends a quotation using the Korean quotation template.

A series of negotiation requests and a revised quotations by the seller may or may not occur. At this point the transaction process may continue on until order process is completed (a purchase order by buyer and finally a purchase order confirmation by seller).

The system provides a method of requesting quotations, ordering, purchasing, selling or otherwise transacting business associated with electronic components over the Internet. However, the present may equally apply to other goods or services.

According to some of the more detailed features of the invention, different options and sets of options can be associated with different classifications of buyers and/or sellers. Furthermore, the system can provide different levels of information as options and sets of options to different classifications of buyers.

While the present invention has been shown and described herein in what is considered to be a preferred embodiment there of, illustrating the results and advantages over the prior art obtained through in the present invention, the invention is not limited to the specific embodiments described above. Thus, the forms of the invention shown and described herein are to be taken as illustrative and other embodiments may be selected without departing from the spirit and scope of the present invention.

Having thus described the invention, what is claimed is:

1. A multi-lingual messaging system for engaging in electronic commerce, comprising:
one or more computer central processing units;
storage means containing one or more searchable databases storing information pertaining to buyers and sellers of products/services and the products/services available for purchase and sale;
Internet communications means providing system users with Internet-based access and use of said system and transmission of electronic messages among system users and said system;
system software for controlling said system, said software comprising a graphical user interface in the form of a series of user screen display and data input templates for users to send and receive transactional information to other users who understand different languages, said templates being stored in said system storage means in each language used by users of said system and displayed to users in their desired language.

2. The multi-lingual messaging system for engaging in electronic commerce of claim 1, wherein said series of user screen display and data input templates comprise one or more of the following: a system products/services database search screen, a system products/services database search results screen, a system user information screen, a request for quotation screen, a request for quotation notification, a quotation screen, a quotation notification, a negotiation request screen, a negotiation request notification, a purchase order screen, a purchase order notification, a purchase order confirmation screen, and a purchase order confirmation notification.

3. The multi-lingual messaging system for engaging in electronic commerce of claim 1, wherein said Internet communications means comprises one or more Internet communications servers providing for electronic mail communications among system users and said system as well as access to a user web page in the user's desired language, said web page providing user access to said system's graphical user interface.

4. A multi-lingual messaging method for engaging in electronic commerce, comprising the steps of:
providing a user of said method who is seeking to purchase products/services with access to a searchable products/services information database to search for desired items;
providing said user with a series of user screen data and input display templates for said user to send and receive transactional information to sellers of products/services regarding the purchase and sale of products/services selected from said searchable database, said templates being in each said user's desired language;
sending requests for quotation for products/services from said user in said user's desired language template to a seller of said products/services in said seller's desired language template;
sending quotations in response to said requests for quotation from said seller in said seller's desired language template to said user in said user's desired language template; and
providing for said user and said seller to send and receive further communications to consummate the purchase and sale of said products/services, in each of said user's and said seller's desired language template.

5. A system for buyers and sellers of products/services to engage in electronic commerce, comprising one or more central processing units, system software for controlling said one or more central processing units, storage means containing one or more databases with information regarding buyers and sellers and the products/services available, one or more servers providing for Internet-based access and use of said system, means for buyers of products/services to search for products/services for completion of a purchase transaction, means for buyers to input requests for quotation in the buyer's desired language to sellers via said system, means for said system to transmit said requests for quotation to selected sellers in the seller's desired language, means for sellers to input quotations in the seller's desired language and for transmitting said quotations to buyers in the buyer's desired language in response to requests for same.
